(19) United States
(12) Patent Application Publication
(10) Pub. No.: US 2023/0249955 A1
(43) Pub. Date: Aug. 10, 2023

(54) SAFETY APPARATUS FOR AN AERIAL WORK VEHICLE

(71) Applicant: KABUSHIKI KAISHA AICHI CORPORATION, Saitama (JP)

(72) Inventors: Takaaki OBA, Konosu-shi (JP); Sho KARINO, Ageo-shi (JP)

(73) Assignee: KABUSHIKI KAISHA AICHI CORPORATION, Saitama (JP)

(21) Appl. No.: 18/068,667

(22) Filed: Dec. 20, 2022

(30) Foreign Application Priority Data
Feb. 9, 2022 (JP) 2022-018866

(51) Int. Cl. B66F 17/00

(52) U.S. Cl. CPC B66F 17/006

(57) ABSTRACT

A safety apparatus for an aerial work vehicle including a traveling body and a lifting apparatus supporting a work platform provided to the traveling body for lifting the work platform relative to the traveling body, the safety apparatus for the aerial work vehicle comprises a road surface inclination detecting device for detecting an inclination angle of an upcoming travel road surface ahead of the traveling body in a traveling direction; and an actuation restricting device for restricting actuation of the traveling body and/or the lifting apparatus according to the inclination angle of the upcoming travel road surface detected by the road surface inclination detecting device.

### TECHNICAL FIELD

The present invention relates to a safety apparatus for an aerial work vehicle (a vehicle with an aerial work platform).

### TECHNICAL BACKGROUND

An aerial work vehicle is known that can travel with the work platform lifted up vertically by a lifting apparatus. If such an aerial work vehicle enters a sloping road such as a hill, or a raised or lowered part which is different in height, during traveling with the work platform lifted up, its vehicle body may lean significantly. Since keeping traveling with its vehicle body leaning significantly may cause a rollover, such an aerial work vehicle is provided with a safety apparatus for preventing rollovers. For example, a safety apparatus is known that performs travel restriction such as stopping the vehicle when the vehicle body has leaned to a certain extent or more (see for example Japanese Laid-Open Patent Publication No. 2000-281295(A)). Such a safety apparatus is configured, for example, to detect an inclination angle of the vehicle body by an inclination angle detector attached to the vehicle body, and perform travel restriction when this inclination angle exceeds a predetermined reference angle.

### SUMMARY OF THE INVENTION

### Problems to be Solved by the Invention

The above safety apparatus intends to prevent a rollover of the aerial work vehicle by performing travel restriction such as forcing the vehicle to stop, in such a case where the aerial work vehicle traveling on a level road surface enters a raised or lowered part or the like and the vehicle body leans significantly. In contrast, it is safer and more useful to detect in advance a raised or lowered part or the like on a road surface on which the aerial work vehicle is about to travel (referred to as an “upcoming travel road surface”), and prevent the aerial work vehicle from entering the raised or lowered part or the like. Conventionally, a technique is known for sensing in advance the presence of a raised or lowered part on an upcoming travel road surface by using a laser sensor attached to an aerial work vehicle. In this technique, for example, while the aerial work vehicle is traveling, the height of an upcoming travel road surface is sequentially detected at a predetermined time interval by irradiating the upcoming travel road surface with laser light, and if the detection value has significantly changed beyond a predetermined threshold, it is determined that a raised or lowered part is present on the upcoming travel road surface. With such a technique, a raised or lowered part can be sensed in advance. In the case of a sloping road, however, it often exhibits a slight (less than the threshold) height variation (a height variation in transition from a level road surface to a sloping road surface) as compared to a raised or lowered part, which may result in a failure to detect it in advance. Therefore, the problem is that it is difficult to prevent an aerial work vehicle from entering a sloping road and leaning significantly.

The present invention has been made in view of these circumstances, and an object thereof is to provide a safety apparatus for an aerial work vehicle that can prevent the aerial work vehicle from entering a sloping road and leaning significantly.

### Means to Solve the Problems

The present invention is a safety apparatus for an aerial work vehicle including a traveling body capable of traveling and a lifting apparatus supporting a work platform and provided to the traveling body for lifting the work platform relative to the traveling body, the safety apparatus for the aerial work vehicle including: a road surface inclination detecting device (for example, an inclination angle calculation unit 52 in an embodiment) for detecting an inclination angle of an upcoming travel road surface ahead of the traveling body in a traveling direction; and an actuation restricting device (for example, an actuation control unit 51 in the embodiment) for restricting actuation of the traveling body and/or the lifting apparatus according to the inclination angle of the upcoming travel road surface detected by the road surface inclination detecting device.

In the safety apparatus for the aerial work vehicle according to the present invention, it is preferred that the safety apparatus for the aerial work vehicle further include a travel speed detecting device (for example, a travel speed detector 62 in the embodiment) for detecting a travel speed of the traveling body; and a road surface height detecting device (for example, a road surface height detector 61 in the embodiment) for sequentially detecting a road surface height of the upcoming travel road surface at a position at a predetermined distance ahead of the traveling body traveling in the traveling direction at a predetermined time interval, wherein the road surface inclination detecting device finds the inclination angle of the upcoming travel road surface based on a detection value of the travel speed detected by the travel speed detecting device, and also based on a plurality of detection values of the road surface height detected at the predetermined time interval by the road surface height detecting device.

In the safety apparatus for the aerial work vehicle according to the present invention, it is preferred that, after the actuation of the traveling body and/or the lifting apparatus is restricted by the actuation restricting device, if an operation for causing the traveling body to travel in a direction opposite to the traveling direction in which the actuation is restricted is performed, the restriction performed by the actuation restricting device be removed.

In the safety apparatus for the aerial work vehicle according to the present invention, it is preferred that, if the inclination angle of the upcoming travel road surface detected by the road surface inclination detecting device is equal to or more than a predetermined angle, the actuation of the traveling body and/or the lifting apparatus be restricted by the actuation restricting device.

### Advantageous Effects of the Invention

In accordance with the safety apparatus for the aerial work vehicle according to the present invention, since the inclination angle of the upcoming travel road surface ahead of the traveling body in the traveling direction is detected by the road surface inclination detecting device, it can be sensed in advance whether or not the upcoming travel road surface is a sloping road surface according to the inclination angle detected. In addition, since the actuation of the traveling body and/or the lifting apparatus can be restricted by the actuation restricting device according to the inclination angle detected, if the presence of a sloping road surface having an inclination angle equal to or more than a predetermined inclination angle, the traveling body can be stopped, or extending actuation of the lifting apparatus can be prohibited. Therefore, the aerial work vehicle can be prevented from entering a sloping road and leaning significantly.

By configuring the safety apparatus for the aerial work vehicle according to the present invention such that the road surface inclination detecting device finds the inclination angle of the upcoming travel road surface based on a detection value of a travel speed detected by the travel speed detecting device for detecting the travel speed of the traveling body, and a plurality of detection values of a road surface height detected by the road surface height detecting device for sequentially detecting the road surface height of the upcoming travel road surface at a position at a predetermined distance ahead of the traveling body traveling in the traveling direction, the inclination angle of the upcoming travel road surface can be found appropriately during traveling.

By configuring the safety apparatus for the aerial work vehicle according to the present invention such that, after the actuation restriction is performed by the actuation restricting device, if an operation for causing the traveling body to travel in a direction opposite to the traveling direction in which the actuation is restricted is performed, the restriction performed by the actuation restricting device is removed, the actuation restriction can be removed while the entry of the aerial work vehicle into a sloping road is being avoided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is a side view of an aerial work vehicle including a safety apparatus for an aerial work vehicle according to the present invention, with a work platform stowed;

FIG. 2 is a side view of the aerial work vehicle, with the work platform lifted up;

FIG. 3 is a block diagram showing a functional configuration of the safety apparatus;

FIG. 4 is an illustrative diagram illustrating a configuration and action of a road surface height detector provided to a traveling body of the aerial work vehicle;

FIG. 5 is an illustrative diagram illustrating a moving process of the traveling body traveling while detecting a road surface height by the road surface height detector;

FIG. 6 is an illustrative diagram regarding an inclination angle of a sloping road surface; and

FIG. 7 is an illustrative diagram regarding a calculation process of the inclination angle.

### DESCRIPTION OF THE EMBODIMENTS

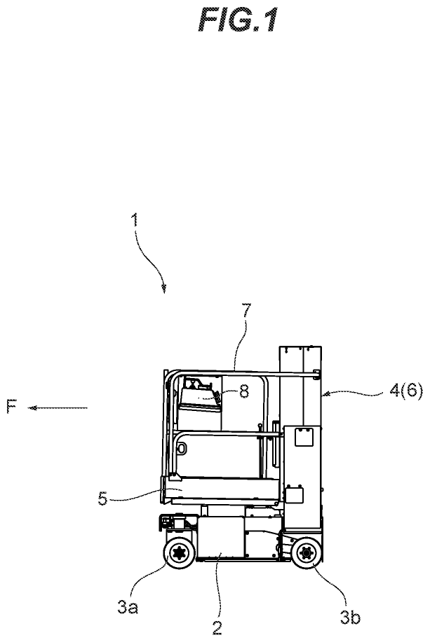

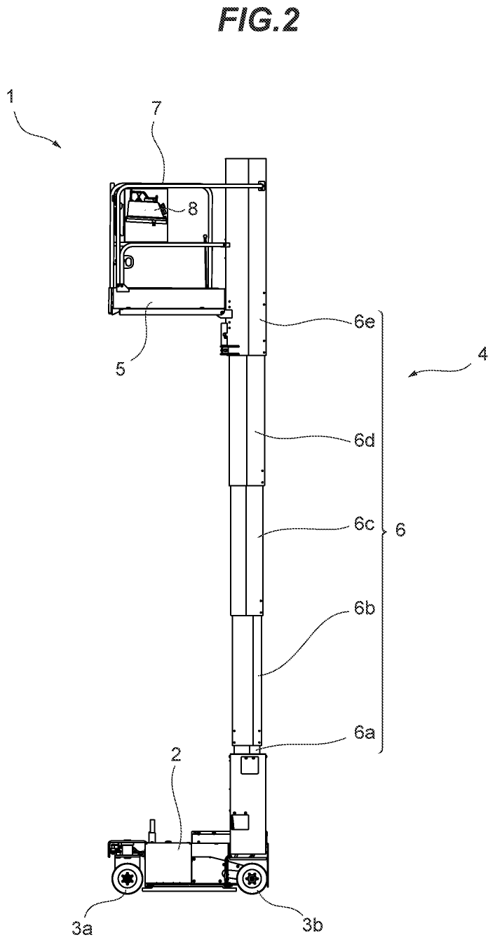

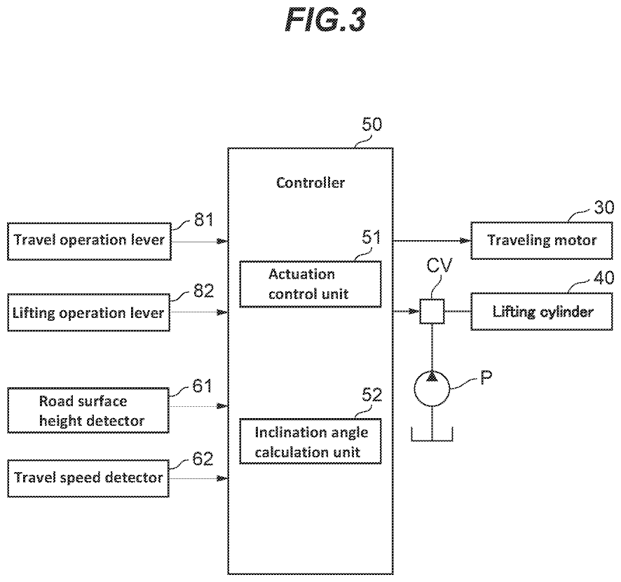

An embodiment of the present invention will be described below with reference to the drawings. FIGS. 1 and 2 show an aerial work vehicle 1 to which the present invention is applied, and FIG. 3 shows a functional configuration of a safety apparatus included in the aerial work vehicle 1. First, with reference to these drawings, an overall configuration of the aerial work vehicle will be briefly described. It should be noted that, in the following description, a direction indicated by an arrow F in FIG. 1 and other drawings is defined as forward.

The aerial work vehicle 1 mainly includes a wheel type traveling body 2 and an extendable mast type lifting apparatus 4 provided to the traveling body 2, and a work platform 5 for a worker to board is attached to the lifting apparatus 4. The traveling body 2 has front and rear wheels 3a, 3b on both right and left sides of its front and rear portions, and is configured to be capable of traveling by steering the front wheels 3a rightward and leftward, and driving the rear wheels 3b by a travel motor 30 (see FIG. 3).

The lifting apparatus 4 has an extendable mast 6 configured by combining a plurality of mast members 6a to 6e extendably in a telescopic form, and an extending and contracting mechanism (not shown) arranged in the extendable mast 6. The extending and contracting mechanism includes, for example, a plurality of hydraulic lifting cylinders 40 (see FIG. 3), a linear member (not shown) such as a chain or wire connecting the plurality of mast members together, and the like. The lift apparatus 4 is configured to be capable of extending and contracting the extendable mast 6 vertically by the hydraulic lifting cylinders 40 being actuated to extend and contract by a hydraulic fluid fed from a hydraulic pump P (see FIG. 3) to the lifting cylinders 40 through a control valve CV (see FIG. 3). The extendable mast 6 is secured to the traveling body 2 at a lower end of the first-level mast member 6a, and the work platform 5 is secured to the fifth-level mast member 6e. A handrail 7 having a substantially U-shape as viewed from above is attached to the mast member 6e and the floor of the work platform 5 so as to surround the worker on board the work platform 5.

The work platform 5 is provided with an operation apparatus 8. This operation apparatus 8 includes a travel operation lever 81 (see FIG. 3) provided so as to be tiltable forward and backward for performing an operation for causing the traveling body 2 to travel, a lifting operation lever 82 (see FIG. 3) provided so as to be tiltable forward and backward for performing an operation for lifting the work platform 5 up and down by extending and contracting the extendable mast 6 of the lifting apparatus 4, and a steering dial (not shown) provided so as to be turnable rightward and leftward for performing an operation for turning the front wheels 3a.

When the travel operation lever 81 is operated, a travel operation signal corresponding to the operation direction and amount is inputted into a controller 50 (see FIG. 3). An actuation control unit 51 of the controller 50 performs control for causing the traveling body 2 to travel by controlling the rotation direction and rotation speed of the travel motor 30 according to the travel operation signal inputted. When the lifting operation lever 82 is operated, a lifting operation signal corresponding to the operation direction and amount is inputted into the controller 50. The actuation control unit 51 of the controller 50 performs control for actuating the extendable mast 6 to extend or contract by controlling feeding of the hydraulic fluid to the lifting cylinders 40 with the control valve CV according to the lifting operation signal inputted.

The worker on board the work platform 5 operates the operation apparatus 8 to actuate the lifting cylinders 40 to extend and contract the extendable mast 6, thereby lifting the work platform 5 vertically so that the worker can work at height. In addition, the operation apparatus 8 can be operated to drive the rear wheels 3b and steer the front wheels 3a, so that the aerial work vehicle 1 (the traveling body 2) can travel with the work platform 5 lifted up.

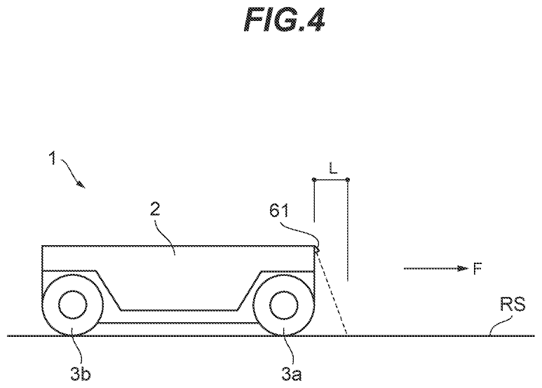

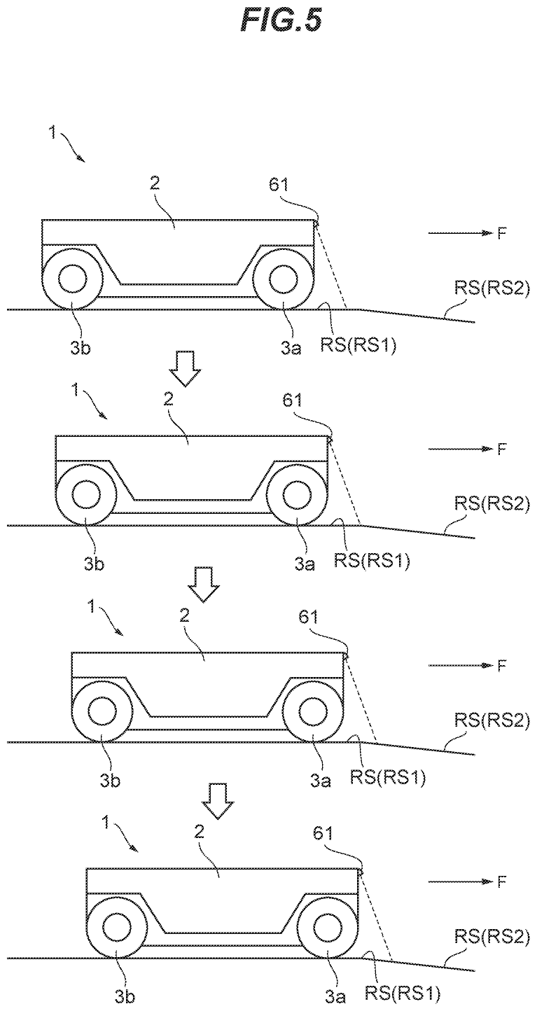

Next, a configuration and action of the safety apparatus provided to the aerial work vehicle 1 will be described with additional reference to FIGS. 4 to 7. It should be noted that only the traveling body 2 of the aerial work vehicle 1 is schematically shown in FIGS. 4 and 5. The safety apparatus mainly includes the controller 50, a road surface height detector 61, and a travel speed detector 62 shown in FIG. 3.

The road surface height detector 61 includes, for example, a time-of-flight (TOF) laser sensor, which is attached to a front end of the traveling body 2, as shown in FIG. 4 (another one attached to a rear end thereof, though not shown). While the traveling body 2 is traveling, the road surface height detector 61 intermittently irradiates with laser light (pulsed laser light) an upcoming travel road surface RS at a position at a predetermined distance L ahead of the traveling body 2 in its traveling direction at a predetermined time interval (for example, every 0.01 second, though the time interval can be appropriately set and may not necessarily be a regular time interval), and receives the laser light reflected to return from the laser light irradiation position each time. Subsequently, the road surface height detector 61 measures a distance from the road surface height detector 61 to the laser light irradiation position based on a lapse of time from the laser light irradiation until its return, and detects the height of the upcoming travel road surface RS at the laser light irradiation position based on the distance measurement value. For example, a correspondence relation between the distance measurement value and the road surface height detection value is found in advance, and the road surface height detection value is calculated from the distance measurement value based on the correspondence relation. In this manner, the road surface height detector 61 calculates the road surface height detection value at the predetermined time interval. Each time the road surface height detector 61 calculates the road surface height detection value at the predetermine time interval, it outputs to the controller 50 a road surface height detection signal corresponding to the road surface height detection value. It should be noted that a road surface height detected when the upcoming travel road surface RS at the laser light irradiation position is a level road surface is hereinafter referred to as a reference road surface height.

The travel speed detector 62 detects, for example, the rotation speed of the travel motor at a predetermined time interval (for example, every 0.1 second, though the time interval can be appropriately set and may not necessarily be a regular time interval), and calculates the travel speed of the traveling body 2 (the aerial work vehicle 1) based on the rotation speed detection value. Each time the travel speed detector 62 calculates the travel speed of the traveling body 2, it outputs to the controller 50 a travel speed detection signal corresponding to the travel speed calculation value.

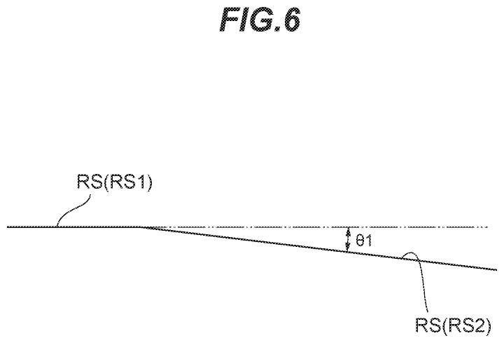

An inclination angle calculation unit 52 of the controller 50 calculates the inclination angle of the upcoming travel road surface RS (the angle inclination of a second upcoming travel road surface RS2 which will be described later) based on the road surface height detection signal (the road surface height detection value) from the road surface height detector 61 and the travel speed detection signal (the travel speed calculation value) from the travel speed detector 62. An example of a calculation procedure therefor will be described below. In this example, a case will be described by way of example where, as shown in FIG. 5, the travel road surface RS, on which the traveling body 2 (the aerial work vehicle 1) is moving in the forward direction F, transitions from a first upcoming travel road surface RS1 which is a level road surface to the second upcoming travel road surface RS2 which is a sloping road surface having a downward gradient. In this case, the laser light irradiation position of the road surface height detector 61 during traveling of the traveling body 2 moves from on the first upcoming travel road surface RS1 onto the second upcoming travel road surface RS2 with the lapse of time. The inclination angle of the second upcoming travel road surface RS2 here, as shown in FIG. 6, refers to an angle between the first upcoming travel road surface RS1 which is a level road surface and the second upcoming travel road surface RS2 which is a sloping road surface (an angle indicated by θ1 in FIG. 6).

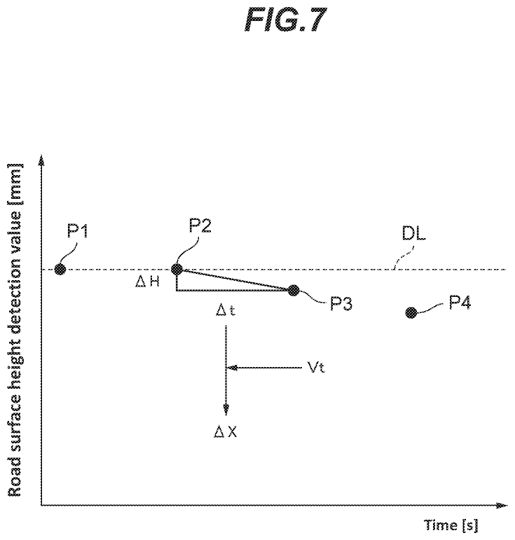

FIG. 7 shows a graph where points (plots P1 to P4) are plotted which represent a plurality of (four in this example) road surface height detection values (unit: millimeter) detected at a time interval Δt (hereinafter referred to as “unit time Δt”) (unit: second) by the road surface height detector 61. A dashed line DL drawn horizontally on the graph indicates a position corresponding to the reference road surface height. The plot P1 shown by way of example on the graph corresponds to a road surface height detection value when the laser light irradiation position of the road surface height detector 61 falls on the first upcoming travel road surface RS1, and the plot P2 corresponds to a road surface height detection value when the laser light irradiation position falls on a boundary between the first upcoming travel road surface RS1 and the second upcoming travel road surface RS2. In addition, the plot P3 and the plot P4 each correspond to a road surface height detection value when the laser light irradiation position falls on the second upcoming travel road surface RS2.

The inclination angle calculation unit 52 of the controller 50 finds a difference value ΔH between, for example, the road surface height detection value of the Plot P2 and the road surface height detection value of the Plot P3, using the road surface height detection signals (the road surface height detection values) from the road surface height detector 61. This difference value ΔH is equivalent to a variation in the road surface height detection value per unit time Δt, and also equivalent to a difference between the height of the second upcoming travel road surface RS2 at the laser light irradiation position corresponding to the Plot P2 and the height of the second upcoming travel road surface RS2 at the laser light irradiation position corresponding to the Plot P3.

In addition, the inclination angle calculation unit 52 finds a travel distance ΔX per unit time Δt of the traveling body 2, using the travel speed detection signals (the travel speed calculation values (Vt)) from the travel speed detector 62 and the unit time Δt (ΔX=Δt×Vt). Subsequently, based on the difference value ΔH found (the variation in the road surface height detection value per unit time Δt) and the travel distance ΔX per unit time Δt, the inclination angle calculation unit 52 uses an arctangent function to calculate an inclination angle 81 of the sloping road surface RS1 (θ1=arctan(ΔH/ΔX)). Following the above procedure, the inclination angle calculation unit 52 can calculate the inclination angle θ1 of the second upcoming travel road surface RS2. Though in this example the inclination angle θ1 is calculated using two road surface height detection values (the road surface height detection value of the Plot P2 and the road surface height detection value of the Plot 3), the inclination angle θ1 may be calculated using three or more road surface height detection values. In addition, the inclination angle θ1 may be calculated only if a plurality of (for example, five, but any number may be set appropriately) road surface height detection values sequentially increase or decrease in arithmetic progression.

If, for example, the inclination angle θ1 calculated by the inclination angle calculation unit 52 is equal to or more than a predetermine angle (for example, 2.0°, but any angle may be set appropriately), the actuation control unit 51 of the controller 50 determines that the second upcoming travel road surface RS2 is a sloping road surface, and restricts the actuation of the traveling body 2 and/or the lifting apparatus 4. For example, the actuation control unit 51 performs control for stopping the travel motor 30 to stop the traveling body 2, regardless of operation of the travel operation lever 81. In addition, the actuation control unit 51 performs control for stopping the actuation of the lifting cylinders 40 to stop the extending actuation of the lifting apparatus 4 (the extendable mast 6), regardless of operation of the lifting operation lever 82. It should be noted that if the operation of contracting the extendable mast 6 is in progress, the contracting actuation of the extendable mast 6 performed by that operation may be allowed. In this manner, the actuation of the traveling body 2 and/or the lifting apparatus 4 is restricted according to the inclination angle θ1 calculated by the inclination angle calculation unit 52, thus preventing the traveling body 2 (the aerial work vehicle 1) from entering a sloping road and leaning significantly. In addition, the aerial work vehicle 1 can be prevented from entering a sloping road having an inclination angle beyond its climbing ability, and having trouble moving forward.

In addition, after the restriction on the actuation of the traveling body 2 and/or the lifting apparatus 4, if an operation for causing the traveling body 2 to travel away (backward) from the second upcoming travel road surface RS2 is performed by the travel operation lever 81, the actuation control unit 51 removes the actuation restriction. In this manner, the actuation restriction can be removed while the entry of the aerial work vehicle 1 into a sloping road is being avoided.

Though an embodiment of the present invention has been described above, the present invention is not limited to the above embodiment, but may be appropriately modified. For example, the above embodiment uses a laser-light TOF sensor as a road surface height detecting device (the road surface height detector), but may use a different type of ranging sensor such as an ultrasonic TOF sensor. In addition, an imaging camera for capturing an image of an upcoming travel road surface may be provided to detect an inclination angle of an upcoming travel road surface by image recognition.

In addition, in the above embodiment, the aerial work vehicle to which the present invention is applied has been described by way of example as a wheel type and extendable mast type aerial work vehicle. The aerial work vehicle, however, is not limited thereto, but may be, for example, a crawler type and extendable mast type aerial work vehicle, or a wheel or crawler type and scissors link type aerial work vehicle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This invention claims the benefit of Japanese Patent Application No. 2022-18866 which is hereby incorporated by reference.

### EXPLANATION ABOUT NUMERALS AND CHARACTERS

1 Aerial work vehicle
2 Traveling body
4 Lifting apparatus
5 Work platform
6 Extendable mast
8 Operation apparatus
50 Controller
51 Actuation control unit (Actuation restricting device)
52 Inclination angle calculation unit (Road surface inclination detecting device)
61 Road surface height detector (Road surface height detecting device)
62 Travel speed detector (Travel speed detecting device)

1. A safety apparatus for an aerial work vehicle including a traveling body capable of traveling and a lifting apparatus supporting a work platform and provided to the traveling body for lifting the work platform relative to the traveling body, the safety apparatus for the aerial work vehicle comprising:
a road surface inclination detecting device for detecting an inclination angle of an upcoming travel road surface ahead of the traveling body in a traveling direction; and
an actuation restricting device for restricting actuation of the traveling body and/or the lifting apparatus according to the inclination angle of the upcoming travel road surface detected by the road surface inclination detecting device.

2. The safety apparatus for the aerial work vehicle according to claim 1, further comprising
a travel speed detecting device for detecting a travel speed of the traveling body; and
a road surface height detecting device for sequentially detecting a road surface height of the upcoming travel road surface at a position at a predetermined distance ahead of the traveling body traveling in the traveling direction at a predetermined time interval, wherein
the road surface inclination detecting device determines the inclination angle of the upcoming travel road surface based on a detection value of the travel speed detected by the travel speed detecting device, and also based on a plurality of detection values of the road surface height detected at the predetermined time interval by the road surface height detecting device.

3. The safety apparatus for the aerial work vehicle according to claim 1, wherein after the actuation of the traveling body and/or the lifting apparatus is restricted by the actuation restricting device, if an operation for causing the traveling body to travel in a direction opposite to the traveling direction in which the actuation is restricted is performed, the restriction performed by the actuation restricting device is removed.

4. The safety apparatus for the aerial work vehicle according to claim 1, wherein if the inclination angle of the upcoming travel road surface detected by the road surface inclination detecting device is equal to or more than a predetermined angle, the actuation of the traveling body and/or the lifting apparatus is restricted by the actuation restricting device.
